(19) United States
(12) Patent Application Publication
(10) Pub. No.: US 2007/0282898 A1
(43) Pub. Date: Dec. 6, 2007

(54) AUTOMATED LOCAL INSERTION OF CONTENT INTO MASTER PLAYLIST IN DIGITAL SIGNAGE NETWORKS

(75) Inventors: Gavin Stark, St. Petersburg, FL (US); Michael L. Baron, Longwood, FL (US); Jesse Goldberg, Palmetto, FL (US)

Correspondence Address: FOGG & POWERS LLC, 10 SOUTH FIFTH STREET, SUITE 1000, MINNEAPOLIS, MN, 55402, US

(73) Assignee: REAL DIGITAL MEDIA, LLC, Sarasota, FL (US)

(21) Appl. No.: 11/739,234

(22) Filed: Apr. 24, 2007

Related U.S. Application Data
(60) Provisional application No. 60/746,546, filed on May 5, 2006.

(51) Int. Cl. G06F 7/00

(52) U.S. Cl. 707/103 R

(57) ABSTRACT

Systems and methods for a digital signage network are provided. In one embodiment, a method for delivering multimedia content in a digital signage network is provided. The method comprises: creating a master playlist on a content server for a digital signage network, the master playlist having a plurality of slots; assigning a first universal media identifier to at least a first slot of the plurality of slots; assigning a first placeholder to at least a second slot of the plurality of slots; and transmitting the master playlist to a plurality of local media players of the digital signage network. The first universal media identifier identifies a first universal content file for display by the plurality of local media players. The first placeholder identifies a slot in the master playlist wherein associated targeted media content is displayable by one or more of the plurality of local media players.

### BACKGROUND

A digital signage network is defined as a set of displays, such as, but not limited to plasma display panels (PDPs), liquid crystal displays (LCDs), computer monitors, projectors, light emitting diode displays (LEDs) and cathode ray televisions (CRTs), that show multimedia content designed and controlled by a central network operator. One use of digital signage is to replace traditional signs, televisions and other displays in retail, entertainment, hospitality, waiting rooms and other areas where people stand in lines or sit in waiting rooms while shopping.

The advantages of digital signage include the ability to quickly and remotely update content via high speed communications such as broadband internet connections (such as but not limited broadband cable, DSL, fiber optic or wireless), corporate wide area networks, satellite links, or via slower methods including dial-up, or frame relay connections. The ability to deliver targeted messages to niche audiences in known locations prompts higher advertising recall rates and increased sales on promoted items. In digital signage networks, instead of showing standard television programming without any control of programs or commercial content, network operators can display content of their choice aimed at that particular audience that varies over time or repeats as desired. Network operators can change the content or promotions at any time they wish. In addition, embodiments of the present invention enable the digital signage network to automatically regulate the playback of content based on criteria such as dates upon which the content should begin to be displayed, and dates upon which the content should stop begin displayed.

The content displayed on the displays of the digital signage network is a set of individual multimedia files including video, audio, still images, animation, text, HTML, syndicated content and combinations (MPEG, JPEG, Windows Media Format (WMV), QuickTime, GIF, DiVX, VOB, Macromedia Flash, RSS, HTML, etc.) compiled into a playlist. The local player stores the content as digital files and outputs the files containing audio, video and still images and other files to the display devices connected to the digital signage network. The multimedia content may include but not be limited to entertainment, news, sports, business, advertising, promotions, education and other programming. In the art today, playlist creation occurs when the digital files are specified in a playout order, the number of times in a particular time period that they will repeat, and the duration of their appearance in terms of numbers of days, weeks or months. The completed playlist tells the local playback device what content to play and when to play the content.

Digital signage systems can create a universal set of content that is applicable across all locations, while customizing unique local content that satisfies the individual needs of each location. For example, a network in waiting rooms of pediatricians across the US may show the same content covering flu shots, cold remedies, good hygiene practices and other related content. Yet each office might desire to display content concerning the individual practices or employees at each location. A video of Dr. Smith making rounds or a still image of Nurse Jones with her picture and name is often desirable. For a network in the produce department of a grocery chain the standard content would cover the preparation and freshness of a variety of fruits and vegetables. However, each store may want to show the local produce manager of the month, his/her picture and a short statement about his/her commitment to family and high standards or a short spot promoting the sale for a limited period of time of a product overstocked in the particular location.

A major problem in digital signage networks as they exist in the art today is the extreme difficulty of creating a broad set of content that is generic enough to run on all locations in a network while incorporating unique and valuable local content for display to a subset of the network. Currently, placing an additional piece of multimedia content in just one location or a subset group from within the broader network requires creating a new playlist containing all of the files from the existing playlist with the addition of the new piece of media specific to that location or subset group. As a result, a 1,000-node network utilizing one master playlist but requiring a unique variation for each location, would require 1,000 individual playlists be created, saved and associated with the correct destination. This previous process required three steps. The first step was the creation of individual playlists, the number of which has to match the number of locations with different content. The second step is the association of that same number of playlists with the correct location containing a multimedia device. Finally, the now-localized playlist is deployed to the right multimedia player. This tedious and repetitious process requires the operator take great care in the creation, association, and deployment process in order to avoid making an error that would result in the wrong content being displayed at a location. Additionally, changes to the common content are now complicated due to the fact that in current practice it is now copied to 1,000 individual playlists.

For the reasons stated above and for other reasons stated below which will become apparent to those skilled in the art upon reading and understanding the specification, there is a need in the art for improved system and methods for providing specialized local content to displays within a subset of a digital signage network.

### SUMMARY

The Embodiments of the present invention provide improved methods and systems for a digital signage network and will be understood by reading and studying the following specification.

Systems and methods for a digital signage network are provided. In one embodiment, a method for delivering multimedia content in a digital signage network is provided. The method comprises: creating a master playlist on a content server for a digital signage network, the master playlist having a plurality of slots; assigning a first universal media identifier to at least a first slot of the plurality of slots; assigning a first placeholder to at least a second slot of the plurality of slots; and transmitting the master playlist to a plurality of local media players of the digital signage network. The first universal media identifier identifies a first universal content file for display by the plurality of local media players. The first placeholder identifies a slot in the master playlist wherein associated targeted media content is displayable by one or more of the plurality of local media players.

### DRAWINGS

The present invention is more easily understood and further advantages and uses thereof more readily apparent, when considered in view of the description of the preferred embodiments and the following figures in which:

FIG. 1 is a block diagram illustrating a digital signage network of one embodiment of the present invention;

FIG. 2 is a diagram illustrating a master playlist of one embodiment of the present invention;

FIG. 3 is a flowchart of a method of one embodiment of the present invention; and

FIG. 4 is a flowchart of a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide systems and methods to automatically place unique digital files into a master playlist running on a network of digital signs powered by multimedia appliances or personal computers without requiring an operator to create unique playlists for each signage location on the network.

Embodiments of the present invention automate the time consuming and tedious process of creating individual playlists by mixing unique local content to be placed on a specified media player (e.g., a specific display or group of displays within the digital signage network) with generic content running across the entire digital signage network. More specifically, the invention allows the network operator to add unique local content to an already-existing playlist running across a wider network with simple commands via application software. By solving the problem of placing local content onto a network of many players without requiring the creation of individual playlists and by launching each separate playlist onto a unique multimedia player at a different location, the invention enables the operator to automate the task of placing custom local content across a large digital signage network.

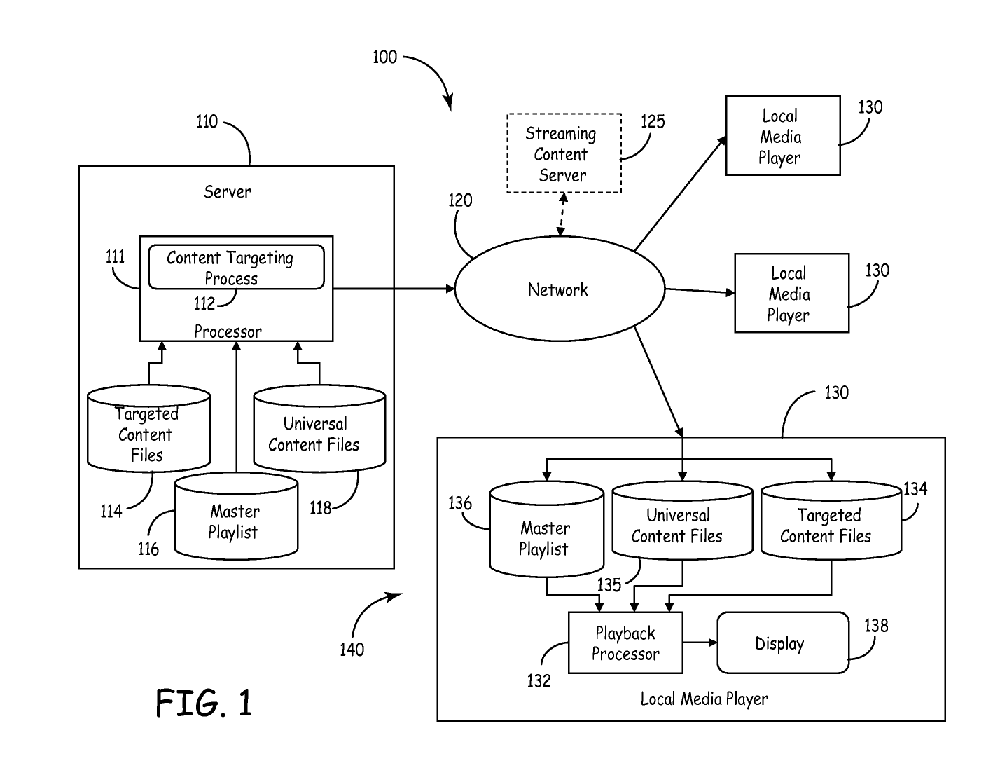

FIG. 1 is a block diagram of a digital signage network 100 of one embodiment of the present invention. Digital signage network 100 comprises a content and database server (referred to herein as content server 110) communicatively coupled to a plurality of local multimedia players 130 via a distribution network 120. In the embodiment shown in FIG. 1, content server 110 is a general purpose computer or server, such as but not limited to a personal computer or an industrial server. In other embodiments, specialized processing equipment may be used to implement the functionality of content server 110 as described herein. As shown in FIG. 1, content server 110 includes a memory storage device for storing targeted content files (shown at 114 as “targeted content files”), a memory storage device for storing universal content files (shown at 118 as “universal content files”), and a memory storage device for storing a master playlist (shown at 116 as “master playlist”). It would be appreciated by one or ordinary skill in the art upon reading this specification that targeted content files 114, universal content files 118 and master playlist 116 may all reside on a single memory storage device or a plurality of memory storage devices. Such memory storage devices may include, but are not limited to, a hard drive or a flash memory. Content server 110 also includes a processor 111 programmed to implement a content targeting process 112 (described in greater detail below) coupled to targeted content files 114, universal content files 118 and master playlist 116.

Distribution network 120 includes those functionalities required for delivering multimedia files from content server 110 to local multimedia players 130. In one embodiment, distribution network 120 is an internet protocol (IP) network. In alternate embodiments, distribution network 120 may include any combination of communications means suitable for delivering multimedia files from content server 110 to local multimedia players 130, such as, but not limited to high speed communications links, broadband internet connections, corporate wide area networks, satellite links, dial-up communications over a telephone link, or frame relay connections.

Local media players 130 each include those functionalities required for displaying multimedia content received from content server 110 via distribution network 120, based on a playlist provided by content server 110, as described in greater detail below. In alternate implementations of digital signage network 100, local media players 130 may be implemented using a general purpose computer, such as but not limited to a personal computer, or specialized processing equipment, or a combination thereof.

As shown in FIG. 1, in one embodiment, at least one of the local media players 130 (shown generally at 140) includes a memory storage device for storing a local copy of master playlist 116 from server 110 (shown as master playlist 136). Local media player 140 also comprises a memory storage device for storing universal content files 135 and a memory storage device for storing targeted content files 134, both of which are provided by server 110 from universal content files 118 and targeted content files 114, respectively. It would be appreciated by one or ordinary skill in the art upon reading this specification that master playlist 136, universal content files 135, and targeted content files 134 may reside on a single common memory storage device or a plurality of memory storage devices. Such memory storage devices may include, but are not limited to, a hard drive or a flash memory. The local media player 140 also includes a playback processor 132 coupled to master playlist 136, universal content files 135, and targeted content files 134, which includes interfaces and programming required to display the multimedia content stored in universal content files 135 and targeted content files 134 onto at least one display 138 as prescribed by master playlist 136. Local multimedia players 130 are distributed across various locations such as, but not limited to offices, retail stores, gas stations, theaters, hotels and malls. Alternatively, a plurality of Local multimedia players 130 may also be distributed across different areas of a common location, such as, but not limited to, a corporate or university campus.

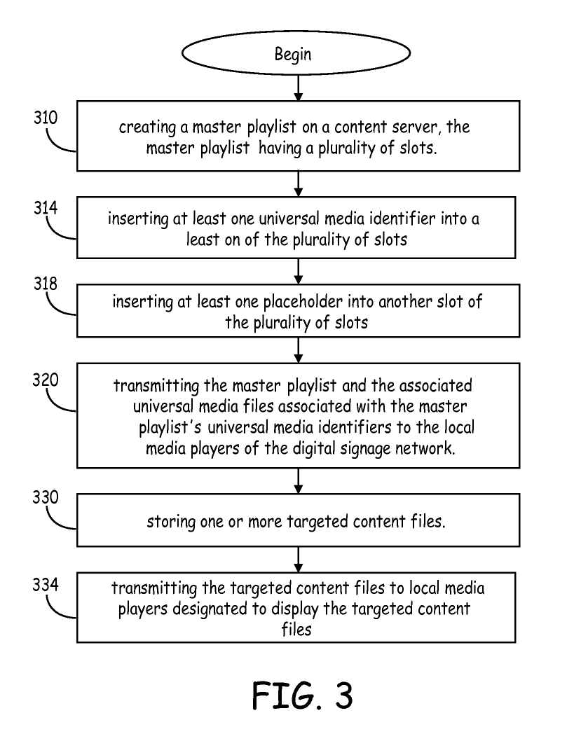

In alternate embodiment, at least one of the local media players 130 receives one or both of universal content files 118 and targeted content files 114 as media content streamed directly from a media source coupled to network 120. In one implementation of such an embodiment, the media source could be server 110 or the media source could be another streaming content server (shown at 125). In those cases, a playback processor, such as processor 132, includes interfaces and programming required to display the multimedia content stored received as streaming content onto at least one display as prescribed by a master playlist. Further details regarding streaming content are described below with respect to FIG. 3.

Local multimedia players 130 display the multimedia content they receive from server 1 10. The universal content files and targeted content files can include content such as, but not limited to video, any combination of audio, still images, animation, text, hyper-text markup language content (HTML), and syndicated content. The multimedia files may include file types such as, but not limited to Moving Picture Experts Group (MPEG) files, Windows Media Video (WMV), QuickTime, Joint Photographic Experts Group (JPEG) files, Graphics Interchange Format (GIF) files, DiVX Media Format (DMF) files, DVD-Video format files (VOB), Macromedia Flash, Really Simple Syndication (RSS) files, hypertext markup language (HTML) files, and so forth. Embodiments of the present invention are not limited to any particular multimedia file type and other file types for transferring multimedia content are contemplated as within the scope of the present invention.

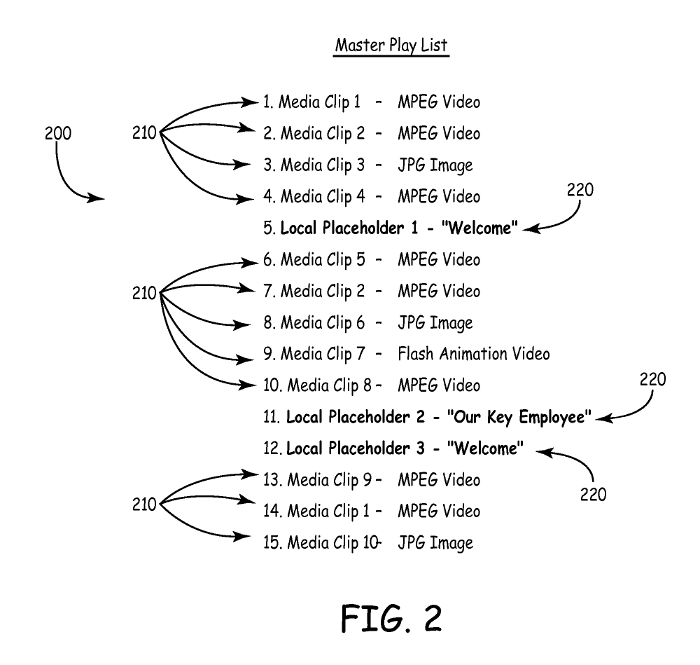

Local multimedia players 130 each independently display universal content files 135 and targeted content files 134 based on a master playlist provided by content server 110 that is common to all local media players 130. One example of such master playlist is illustrated in FIG. 2 as master playlist 200. Master playlist 200 describes both the multimedia content that will be displayed by each of the local multimedia players 130 and the order in which the multimedia content is displayed. Each local multimedia player 130 plays the multimedia content in the order described by playlist 200, and then the multimedia content is repeated in the same order throughout the day, or until a new playlist is received. One of the advantages provided by embodiments of the present invention is that each of the local multimedia players 130 across the digital signage network 100 is sent a copy of a common single master playlist that enables any given local multimedia player (such as local multimedia player 140) to provide multimedia content that is targeted for a local audience at just its location.

As shown by example in FIG. 2, a master playlist (shown generally at 200) comprises a content listing that includes both universal media identifiers 210 (shown as media clips 1 through 10) and local placeholders (shown generally at 220) inserted into slots (illustrated by “1.” to “15.”) of master playlist 200. A network operator of digital signage network 100 assembles a collection of universal content files 118 having multimedia content that will be displayed across all of the local multimedia players 130 and for each piece of this multimedia content, an associated universal media identifier 210 is inserted into master playlist 200. A listing of the universal multimedia identifiers 210 is organized into master playlist 200, describing the order and frequency in which the associated universal multimedia files 118 will be displayed by local multimedia players 130. In other words, each universal media identifier 210 identifies an associated file from universal content files 118. In a similar way, the network operator also inserts placeholders 220 into master playlist 200. Each placeholder 220 defines a slot in the playlist that is given a title but otherwise left without any specified associated content. In other words, each placeholder 220 represents a slot in playlist 200 wherein multimedia content specifically targeted for specific local multimedia players 130 can be displayed, if desired. A placeholder can be given any descriptive name the network operator chooses to use, such as “Welcome”, “On-sale today”, “Our Key Employee”. The placeholder is placed into the master playlist 200 into the slot where the network operator wishes the targeted content to play, if and when any is available for an individual player. For example, referring to FIG. 2, all local multimedia players 130 running playlist 200 will first display media clip 1, media clip 2, media clip 3, and media clip 4 because universal multimedia identifiers 210 associated with these media clips occupy the first four slots of playlist 200. Slot number 5 of playlist 200 is a placeholder 220. The placeholder 220 at slot number 5 provides each of the local multimedia players 130 an opportunity to display site specific (i.e. “targeted”) content.

As shown in FIG. 2, slots 5 and 12 are specifically a placeholder for a targeted “Welcome” message while slot 11 provides a placeholder for “Our Key Employee.” Any number of placeholders can be inserted into a master playlist. Once the network operator has completed inserting the desired set of placeholders, master playlist 200 is saved onto content server 110 into master playlist memory 116. Content server 110 broadcasts master playlist 200 to each of the local multimedia players 130. At this time, content server 110 can also optionally broadcast the multimedia files 118 associated with the universal multimedia identifiers 210. At this point, there is no need for the network operator to associate any content with the placeholders 220. Local multimedia player 140 stores a local copy of the master playlist 200 (into 136) and also stores the universal content media clips (into 135).

When an end user or other designated party with content placement authorization for one of the local multimedia players 130 notifies the network operator of targeted content they wish do display, embodiments of the present invention enable the network operator to easily place the targeted content onto that end user's particular local multimedia player (local multimedia player 140 for example) without having to create a separate playlist for the end user's particular local multimedia player. Instead, a network operator simply uploads the targeted content to the targeted content files 114 of server 110 and executes content targeting process 112 to launch (i.e. transmit) the targeted content files to those local multimedia players 130 where the targeted content will be displayed, or to those streaming content servers 125 that will later stream the content to local multimedia players 130. Once the targeted content files 114 are loaded onto content server 110, they can be launched by the network operator either one at a time or in batch. Targeted content is then automatically and correctly displayed on local multimedia players 130 as provided by associated placeholders 220 in master playlist 200. There is no need to create and send a modified master playlist to any of the local multimedia players 130 in order to have them display newly received targeted content.

FIG. 3 is a flow chart illustrating a method for implementing a content targeting process (such as content targeting process 112, for example) of one embodiment of the present invention for delivering targeted content to a local media player of a digital signage network. The method may be initiated manually by a network operator, or set to initiate automatically based on a schedule or any other criteria deemed relevant by the network operator.

The method begins at 310 with creating a master playlist on a content server, the master playlist having a plurality of slots. The method proceeds to 314 with inserting at least one universal media identifier into a least on of the plurality of slots. As described above, a universal media identifier identifies an associate universal content file whose content should be displayed by a local media player during that slot, as the local media player sequences through the slots of the master playlist. These media files and their associated content are referred to as “universal” because their content will be displayed by every local media player of the digital signage network, or by a pre-selected grouped sub-set number of players 130 of the whole network.

The method next proceeds to 318 with inserting at least one placeholder into another slot of the plurality of slots. The at least on placeholder defines a slot in the master playlist that is given a title but otherwise left without any specified associated content. The at least one placeholder represents a slot in the master playlist wherein multimedia content specifically targeted for specific local multimedia players may be displayed, if desired.

The method next proceeds to 320 with transmitting the master playlist and the associated universal content files associated with the master playlist's universal media identifiers to the local media players of the digital signage network.

In one embodiment, block 320 may be manually initiated by the network operator, or scheduled to be initiated at a designated time, or based on the occurrence of another triggering event. In one embodiment, block 320 comprises executing a program on server 110 that reads master playlist 116 from memory and analyzes each slot of master playlist to determine which slots include universal media identifiers. The program then locates any associated universal content files stored on server 100 that are identified by the universal media identifiers. The master playlist and those associated universal medial files are then transmitted to the local media players.

As shown at block 330, the method of FIG. 3 further comprises storing one or more targeted content files. The targeted content files include content provided by an end user of at least one of the local multimedia players that the end user wants to display. The content of these files is “targeted” rather than “universal” because it will be displayed only by designated local media players during associated placeholder slots in the master playlist, and not played on any local media player not so designated. In one implementation of the method, the targeted content files are stored on the same content server wherein the master playlist is maintained. In an alternate implementation, the targeted content files are stored on one or more streaming content servers.

The method then proceeds to 334 with transmitting the targeted content files to local media players designated to display the targeted content files. In one embodiment, block 334 comprises executing a program on server 110 that reads master playlist 116 from memory and analyzes each slot of master playlist to determine which slots include placeholders. The program then locates any associated targeted content files stored on server 110 that are identified by the placeholders and transmits those targeted content files to the designated local media players. In one embodiment, when no associated targeted content files exist on the content server, then no targeted content files associated with the placeholders are transmitted to the local media player. In another embodiment, when one targeted content file is associated with a placeholder that appears in multiple slots of the playlist, a copy of the targeted content file is transmitted only once to the local media player.

In another embodiment, block 334 comprises streaming the content of the targeted content files to the local media players. In such an embodiment, the targeted content files are stored on one or more streaming content servers. When the local media player require access to a specific targeted content file (i.e., when the player reaches a placeholder in the local playlist that calls on the player to display content associated with the targeted content file), the local media player requests the content from the one or more streaming content servers, which in turn streams the content for display on the local media player.

As would be appreciated by one of ordinary skill in the art upon reading this specification, streaming content to local media players avoids the need for the local media players to each store copies of the targeted content files on local memory storage devices. While streaming content allows the production of less expensive local media players because of the reduced local storage needs, network availability and/or latency issues may become more of a concern. Local media players that store the content they play on local memory storage devices are less susceptible to network availability and/or latency issues, but may be more expensive to produce and maintain because they include the storage devices. Ultimately, the decision of whether to stream media to local playback devices or store them on the local playback device can be readily made by one of ordinary skill in the art upon studying this specification, based on factors such as but not limited to network reliability and the needs of the end user. In one alternate embodiment, a local media player displays a combination of media received from a streaming content server and media from files stored on a local memory storage device.

Further, although the preceding discussion focuses on streaming verses storage with respect to targeted content files, one of ordinary skill in the art upon reading this specification would appreciate that universal media files may also be streamed to local media players from the one or more streaming content servers in addition to, or as an alternate to, storing such files on a local memory storage device.

As would be appreciated by one of ordinary skill in the art upon studying this specification, the order in which blocks 310 to 334 are performed may be varied from that shown in FIG. 3 and still achieve the same result. Thus the order shown in FIG. 3 should not be construed as limiting the scope of embodiments of the present invention. For example, storing the one or more targeted content files onto the content server may proceed before transmitting the master playlist and associated universal content files at 320.

In one embodiment, the method optionally includes sending a notice of the launch of targeted content to a local media player to the network operator or other designated person such as the end user requesting display of the targeted content. In yet another embodiment, content targeting process 112 provides functionality that allows the network operator to review and monitor the distribution of targeted content files and determine which targeted content files should be playing on which designated local media players.

Referring back to FIG. 1, when a targeted content file is received by a local multimedia player designated to play the file, (local multimedia player 140, for example) the received file is stored into targeted content files 134. The targeted content from the file is automatically inserted into the playback sequence by the playback processor 132 whenever the placeholder associated with the targeted content occurs in the playback cycle. For example, when local multimedia player 140 receives a targeted content MPEG movie file identified by master playlist 200's “welcome” placeholders at slots 5 and 12, the MPEG movie content of the file is displayed during slots 5 and 12 of local multimedia player 140's playback cycle. When local multimedia player 140 receives a targeted content JPEG file identified by master playlist 200's “Our Key Employee” placeholder at slot 11, the JPEG content is displayed during slot 11 of local multimedia player 140's playback cycle. Thus, if a particular placeholder appears once in a master playlist, the targeted content plays once per the playback cycle. If the placeholder appears “n” times in the master playlist, the targeted content plays of that player “n” times automatically without any change in master playlist or manual intervention to create a player specific playlist. Other players that receive different targeted content associated with the “welcome” and “Our Key Employee” placeholders will display that different targeted content during slots 5, 11 and 12.

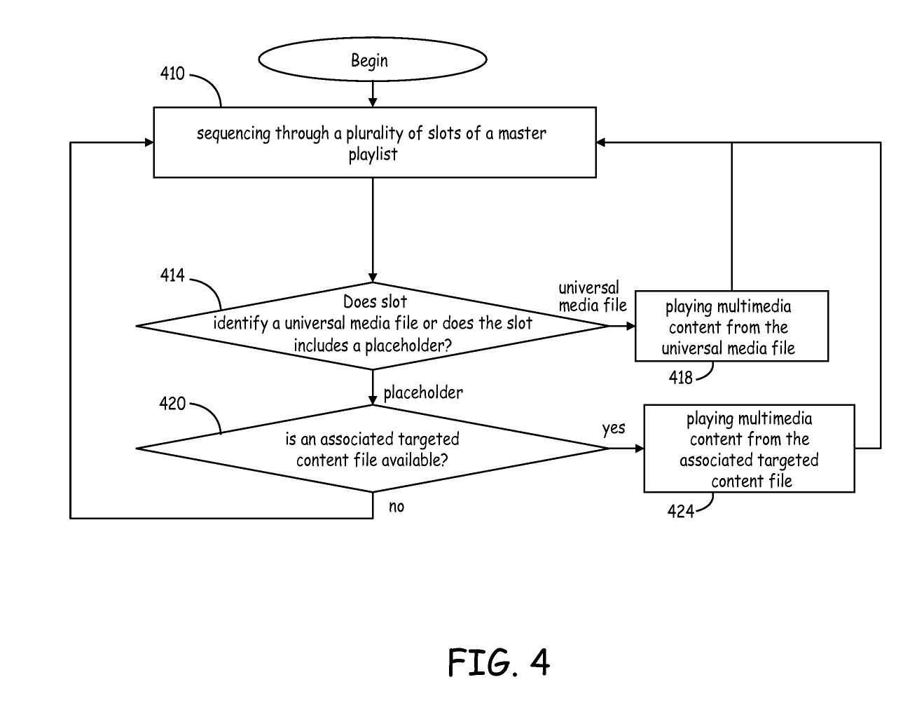

FIG. 4 is a flow chart illustrating a method for displaying targeted content with a local media player of one embodiment of the present invention. The method begins at 410 with sequencing through a plurality of slots of a master playlist. The method proceeds to 414 with determining whether the slot identifies a universal content file or whether the slot includes a placeholder. When the slot identifies a universal content file (determined at 414) the method proceeds with playing multimedia content from the universal content file at 418. The method then returns to 410, sequencing to the next slot of the master playlist sequence. When the slot includes a placeholder (determined at 418) the method proceeds to 420 with determining whether an associated targeted content file is available (i.e., whether the associated targeted content file is either available from a local memory storage device, or available from a streaming content server). When no associated targeted content file is available, the process returns to 410, sequencing to the next slot of the master playlist sequence. When an associated targeted content file is available, the process proceeds to 424 with playing multimedia content from the associated targeted content file. The process returns to 410, sequencing to the next slot of the master playlist sequence.

One important advantage provided by embodiments of the present invention, and illustrated by the method of FIG. 4, is the ability of any local multimedia player to automatically play targeted content during a placeholder if such targeted content is available, or equally important, to understand that no content has been assigned to that particular placeholder and skip to the next slot in the master playlist's playback sequence. The ability to play targeted content during a placeholder when associated targeted content is available, or skip past the placeholder when associated target content is not available, is a highly advantageous feature of the present invention. For example, if JPEG still images of “key employee” nurses in 37 of 40 doctor's office locations in digital signage network 100 are available, the content targeting process 112 will launch targeted content files with the 37 location specific JPEG pictures automatically, ignoring the 3 that are missing. The local media players at the 37 doctor's offices will each receive a JPEG still image of the nurse they have designate to display during the “Our Key Employee” placeholder, while the local media players at the 3 doctor's offices for which there are no pictures available will continue to play the master playlist without inserting the missing targeted content. Again, the master playlist used by all of the local multimedia players 130 is the same and no separate playlists need to be created by the network operator in order to customize the multimedia playback experienced at any particular local multimedia player.

In one alternate embodiment, instead of skipping a placeholder when no specific local content exists, the operator may define a single “default” piece of content to occupy the placeholder's position in the playlist. For example the network operator may define a generic welcome message to be displayed during a “welcome” placeholder slot when an end user has not provided any specific targeted content. This generic content would be displayed every time the slot for the associated placeholder occurs, without further operator intervention, until specific targeted content is provided by the end user.

In one embodiment of the present invention, a naming convention is employed to assist content targeting process 112 in associating targeted content files 114 stored on content server 110 with particular placeholders in the master playlist and optionally with associating those same targeted content files for display on specific local media players, or groups of local media players. In one such embodiment, targeted content files 114 are each saved on content server 110 using a filename that specifies the placeholder within the master playlist the file is associated with, which local multimedia players 130 the targeted content should play on, and the dates for which the targeted content is valid and should be played.

For example, in one embodiment, a filename used to identify a targeted content file is “welcome_p_{—}35_s20060322_e20060427.jpg”. The naming convention used for this filename indicates first that targeted content file is a JPEG file, based on the “.jpg” file extension, and is aimed at a placeholder named “welcome” within the master playlist, based on the name “welcome” occupying the beginning of the file name. The “_p” is a player parameter in the naming convention indicating that the content is to be played on a specific local multimedia player that is identified by the parameter. For example, a “_p35” parameter indicates that the files content is to be played on only local multimedia player that is identified on the network as player number 35 (a player located in New York City, for example). A different targeted content file containing a distinct welcome message for a local multimedia player identified on the network as player number 36 (located in Minneapolis, Minn. for example) would include a “_p36” parameter in the filename. As would be appreciated by one of ordinary skill in the art after studying this specification, any network node numbering or addressing scheme may be used for the player number, including but not limited to an I.P. address of the local multimedia player. In one embodiment, multiple local multimedia players are identified by the file name (“welcome_p35_p36.jpg” for example) to indicate that the targeted content in the file is intended for those multiple players.

In the example provided above, the “_s” and “_e” are starting and ending date parameters, that respectively indicate the start date for which the targeted content is valid and should be played, and the ending date for which the targeted content is valid and should be played. These parameters follow a YYYYMMDD, where YYYY is the year, MM is the month and DD is the day of the month. Thus, the targeted content file “welcome_p35_s20060322_e20060427.jpg” will be scheduled to play in the “welcome” placeholder position on player 35 starting from Mar. 22, 2006 (as specified by _s20060322_) and ending on Apr. 27, 2006 (as specified by _e20060427). In one embodiment, indication of the start and end dates are optional such that a date range without a start date implies any date up to and including the end date, while the absence of an end implies any date on or after the start date. The absence of both dates indicates to the local media player that the targeted content file is always active.

In addition to using the _p, _e and _s parameters, additional parameters are also envisioned to assist digital signage network in determining where and when targeted content should be displayed. For example, through the use of optional parameters, targeted content can be associated with designated local media players based on location or other logical grouping, rather than by identifying individual players. This allows the network operator to define a player group and easily distribute targeted content to local media players bellowing to the group. For example, a _l indicator in the file name may indicate that the content is to be played on every local multimedia player 130 within a physical location or geographic region (such as a specific shopping mall, or a specific city, for example). Similarly, _g may be used to associate contents of a targeted media file for distribution to every local media player belonging to a certain group (such as players installed at all theaters operated by a specific movie theater company, for example) regardless of the physical location of the players. Still other parameters may be used to associate the file with any other logical or physical subset of the digital signage network.

In one embodiment, a content server 110 utilizes the above described naming convention to determine which targeted content files should be transmitted to which local media player. In one implementation of such an embodiment, before transmitting targeted content files to local media players, content targeting processor 112 reads the file names for each of targeted content files 114 and sends those files only to those local media players designed by the file names. In another such implementation, content targeting processor 112 transmits targeted content files 114 local media players based on the starting and ending date parameters indicated by the file names.

In one embodiment, a local media player utilizes the above described naming convention to determine which targeted content files should be associated with placeholders of the master playlist and displayed and perform other file maintenance functions. For example, in one embodiment, a local media player will ignore any targeted content file they receive having a file name that designates a different local media player. In one embodiment, such erroneously delivered targeted content files are flagged for deletion from local memory devices. In another embodiment, a local media player deletes targeted content files that have expired based on an ending date parameters provided by the file name.

In other embodiments, a content server may distribute multimedia content to more that one distinct digital signage network. With such an embodiment, one of ordinary skill in the art upon reading this specification would appreciate that the single content server can simply maintain a separate master playlist for each distinct digital signage network, segregating files associated with each distinct digital signage network within the content server using means known in the art. The processes described above in this specification are simply applied on a network by network basis.

Embodiments of the present invention provide advantageous benefits for distributing both universal and targeted content to numerous and diverse audiences. For example, universal content files can play enterprise branding, merchandise and entertainment content as well as advertising spots intended for a general audience. Targeted content is aimed at a local audience. For example, a retail store can display targeted content such as “Welcome to this local store”, “Your store manager” with a picture and name shown and a voice over saying “serving the (specific name of town or neighborhood) for xxx years” local area weather updates including local forecasts and even updated local radar views. In addition, the targeted content can include weekly or daily sales specials, or an employee of the month. A movie theater can display targeted content before movie previews such as advertising for other nearby businesses or local news. Examples of targeted content that can be distributed to and displayed on individual local media players serving medical service locations include but are not limited to messages that introduce clients to the facilities chief doctor, head lab technician, doctors and nurses-on-duty, and other medical personnel as well as identifying pharmacies in the neighborhood. Further, targeted content can include local health alerts, additional services provided by that office. Examples of targeted content that can be distributed to and displayed on individual local media players at a services location such as a hotel include messages that describe a special of the week at a local restaurant, reduced ticket pricing for one or more theaters close to the hotel, names and pictures of the on duty concierge at the hotel, and fitness trainers at or near the hotel. As described above, end users that do not submit targeted content to the network operator will have no associated targeted content to display at their locations, but are able to keep playing the universal content files, automatically skipping placeholder slots in the master playlist.

Several means are available to implement the systems and methods of the current invention as discussed in this specification. These means include, but are not limited to, digital computer systems, microprocessors, general purpose computers, programmable controllers and field programmable gate arrays. Therefore other embodiments of the present invention are program instructions resident on computer readable media which when implemented by such controllers, enable the controllers to implement embodiments of the present invention. Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

We claim the following:

1. A method for delivering multimedia content in a digital signage network, the method comprising:
creating a master playlist on a content server for a digital signage network, the master playlist having a plurality of slots;
assigning a first universal media identifier to at least a first slot of the plurality of slots;
assigning a first placeholder to at least a second slot of the plurality of slots; and
transmitting the master playlist to a plurality of local media players of the digital signage network;
wherein the first universal media identifier identifies a first universal content file for display by the plurality of local media players; and
wherein the first placeholder identifies a slot in the master playlist wherein associated targeted media content is displayable by one or more of the plurality of local media players.

2. The method of claim 1, further comprising:
transmitting at least a first universal content file to the plurality of local media players of the digital signage network based on the first universal media identifier; and
transmitting at least a first targeted content file to a designated local media player of the plurality of local media players based on the first placeholder.

3. The method of claim 2, wherein transmitting at least a first universal content file to the plurality of local media players further comprises streaming the first universal content file to at least one of the plurality of local media players.

4. The method of claim 2, wherein transmitting at least a first targeted content file to a designated local media player further comprises streaming the first universal content file to the designated local media player.

5. The method of claim 2, wherein one or both of transmitting at least a first universal content file and transmitting at least a first targeted content file comprise transmitting based on an occurrence of a triggering event.

6. The method of claim 1, wherein the first placeholder identifies a slot in the master playlist for displaying associated targeted media content when a targeted media file associated with said associated targeted media content is available to the one or more of the plurality of local media players.

7. The method of claim 1, wherein transmitting the master playlist is manually initiated by a network operator.

8. The method of claim 1, wherein transmitting the master playlist is an event initiated based on an occurrence of a triggering event.

9. The method of claim 1, further comprising:
storing one or more targeted content files onto the content server.

10. The method of claim 9, wherein storing one or more targeted content files onto the content server further comprises storing the one or more targeted content files based on a file naming convention that associates each of the one or more targeted content files with at least one placeholder of the master playlist.

11. The method of claim 9, wherein the file naming convention further provides an indication of when the one or more targeted content files are valid for display.

12. Them method of claim 9, wherein the file naming convention further provides which local media players of the plurality of local media players are designated to receive each of the one or more targeted content files.

13. A server for distributing multimedia content via a digital signage network, the server comprising:
at least one memory device for storing a master playlist, at least one universal content file and at least one targeted content file; and
a processor communicatively coupled to a plurality of local media players of a digital signage network and further coupled to the at least one memory device;
wherein the processor is configured to transmit the master playlist to the plurality of local media players of the digital signage network;
wherein the master playlist includes a plurality of slots, the plurality of slots including at least a first universal media identifier and a first placeholder.

14. The server of claim 13, wherein the processor is further configured to transmit the at least one universal content file to the plurality of local media players based on the master playlist; and
wherein the processor is further configured to transmit the at least one targeted content file to a first local media player of the plurality of local media players based on the master playlist.

15. The server of claim 13, wherein the first universal media identifier identifies a first universal content file for display by the plurality of local media players.

16. The server of claim 13, wherein the first placeholder identifies a slot in the master playlist wherein associated targeted media content is displayable by the first local media player when a targeted media file associated with said first placeholder is available to the first local media player.

17. The server of claim 13, wherein the at least one targeted content file is stored on the at least one memory device based on a file naming convention that provides at least one of an association between the at least one targeted content file and a placeholder of the master playlist, an association between the at least one targeted content file and at least one local media player, and an indication of when each of the at least one targeted content file is valid for display.

18. A method for delivering multimedia content in a digital signage network, the method comprising:
sequencing through a plurality of slots of a master playlist;
determining whether a first slot of the plurality of slots identifies a universal content file; and
determining whether the first slot of the plurality of slots includes a placeholder;
when the first slot identifies a universal content file, playing multimedia content based on the universal content file;
when the slot includes a placeholder, determining when a targeted content file associated with the placeholder is available; and
wherein when the targeted content file associated with the placeholder is available, playing multimedia content based on the targeted content file.

19. The method of claim 18, wherein determining when a targeted content file associated with the placeholder is available further comprises determining whether the targeted content file is available from a streaming content server.

20. The method of claim 18, wherein determining when a targeted content file associated with the placeholder is available further comprises determining whether the targeted content file is available from a local memory device.

21. The method of claim 18, further comprising:
wherein when the targeted content file associated with the placeholder is not available, proceeding to a next slot of the master playlist.

22. The method of claim 18, wherein playing multimedia content based on the targeted content file further comprises:
playing multimedia content based on a file naming convention that provides at least one of an association between at least a first placeholder of the master playlist and a first targeted content file of the plurality of targeted content file, an association between the first targeted content file and at least one local media player, and an indication of when the first targeted content file includes multimedia content valid for display.

23. The method of claim 18, wherein playing multimedia content based on the targeted content file further comprising:
receiving at least one targeted content file from a streaming content server.

24. The method of claim 18, further comprising:
receiving the master playlist from a content server and storing the master playlist;
receiving at least one universal content file from the content server and storing the at least one universal content file; and
receiving at least one targeted content file from the content server and storing the at least one targeted content file.

25. A local media playback device for a digital signage network, the local media playback device comprising:
at least one memory device for storing a master playlist, at least one universal content file and at least one targeted content file; and
a processor coupled to the at least one memory device and at least one display, the processor configured to output multimedia content to the display based on the master playlist, the at least one universal content file and the at least one targeted content file;
wherein the processor is further configured to sequence through a plurality of slots of the master playlist and evaluate the contents of the plurality of slots;
wherein when the processor determines that a first slot of the plurality of slots identifies a first universal content file, the processor is configured to process the universal content file and output content to the at least one display based on the universal content file;
wherein when the processor determines that the first slot of the plurality of slots identifies a first placeholder, the processor is configured to determine whether a first targeted content file of the at least one targeted content file stored in the at least one memory device is associated with the first placeholder; and
wherein when the first targeted content file device is associated with the first placeholder, the processor is configured to process the first targeted content file and output content to the at least one display based on the first targeted content file.

26. The local media playback device of clam 25, wherein when the processor determines that the first slot of the plurality of slots identifies a first placeholder having no associated targeted content file stored in the at least one memory device, the processor is configured to sequence to a next slot of the plurality of slots.

27. The local media playback device of clam 25, wherein when the processor determines that the first slot of the plurality of slots identifies a first placeholder having no associated targeted content file stored in the at least one memory device, the processor is configured to output default content to the at least one display.

28. The local media playback device of clam 25, wherein the processor is further configured to determine whether the first targeted content file is associated with the first placeholder based on a filename of the first targeted content file and a pre-determined naming convention.

29. The local media playback device of clam 28, wherein the processor is configured to determine whether the first targeted content file is associated with the first placeholder based on one or both of a starting data and an ending date provided by the filename of the first targeted content file.

30. The local media playback device of clam 25, further comprising the at least one display device communicatively coupled to the processor, wherein the at least one display device includes at least one of a video display, a cathode-ray-tube video display, a liquid crystal video display, a plasma based video display, a projection based video display, and a audio speaker.

31. The local media playback device of clam 25, wherein the processor is further configured to communicate with a content server and receive the master playlist, the at least one universal content file and the at least one targeted content file from the content server.

32. A local media playback device for a digital signage network, the local media playback device comprising:
a processor coupled to at least one display, the processor configured to output multimedia content to the display based on a master playlist and one or more content files received from a streaming content source;
wherein the processor is further configured to sequence through a plurality of slots of the master playlist and evaluate the contents of the plurality of slots;
wherein when the processor determines that a first slot of the plurality of slots identifies a first universal content file, the processor is configured to process the first universal content file and output content to the at least one display based on the first universal content file;
wherein when the processor determines that the first slot of the plurality of slots identifies a first placeholder, the processor is configured to determine whether a first targeted content file associated with the first placeholder is available; and
wherein when the first targeted content file associated with the first placeholder is available, the processor is configured to process the first targeted content file and output content to the at least one display based on the first targeted content file.

33. The local media playback device of clam 32, wherein the processor is further configured to request one or both of the first universal content file and the first targeted content file from the streaming content source.
